(19) United States
(12) Patent Application Publication
(10) Pub. No.: US 2013/0292212 A1
(43) Pub. Date: Nov. 7, 2013

(54) UNLOCKING CONTROL FOR A LIFT FLOOR DOOR

(71) Applicant: Gabriel FIERRI, Arcegno (CH)

(72) Inventor: Gabriel FIERRI, Arcegno (CH)

(73) Assignee: KONE CORPORATION, Helsinki (FI)

(21) Appl. No.: 13/938,576

(22) Filed: Jul. 10, 2013

Related U.S. Application Data
(63) Continuation of application No. PCT/EP2011/053190, filed on Mar. 3, 2011.

(51) Int. Cl. B66B 5/00

(52) U.S. Cl. CPC B66B 5/00
USPC 187/331

(57) ABSTRACT

Control system for disengaging a safety lock of a lift floor door, comprising: a linear actuation unit; at least one plate in elastically deformable material; at least one actuation cable between said actuation unit and said plate; said actuation unit, said plate and said actuation cable being associated with the lift cabin, in which the actuation cable induces a deformed configuration of said plate, and the plate in deformed configuration disengages said safety lock so as to allow the floor door to open.

This application is a continuation of PCT International Application No. PCT/EP2011/053190 which has an International filing date of Mar. 3, 2011, the entire contents of which are incorporated herein by reference.

### FIELD OF THE INVENTION

The present invention concerns an unlocking control for a lift door. In particular the invention concerns an improvement to known control systems using a retractable sliding shoe for disengaging a safety lock that prevents opening of the floor door in absence of the cabin.

### PRIOR ART

Lifts need a system that enables the floor doors to open only when the cabin is present, for obvious safety reasons. For this purpose it is known to equip the floor door with a safety system, for example a mechanical bolt lock, which prevents the floor doors from opening, except for when the cabin is present. For this purpose the cabin must be able to disengage the lock when it is present. In a known and widely used type of lift, the cabin is equipped with a retractable slider actuated by an electromagnet. When the electromagnet is not excited and the cabin is on the floor, the slider engages the lever of the bolt, unlocking the floor door. The movement of the slider is caused by two short rods that substantially form a parallelogram-shaped articulation.

A drawback of known retractable slider systems is represented by the encumbrance which is not negligible. The slider projects by a considerable amount with respect to the section of the cabin. It should be clear that the bulk is a crucial characteristic since the space in the well is limited. Increasing the outer bulk means decreasing the useful volume of the cabin. Moreover, known systems are not economically suitable for lifts in which the doors of the various floors open in different directions with respect to the well and/or the doors are hinged on the right or on the left.

### SUMMARY OF THE INVENTION

The purpose of the invention is to overcome the limits of the prior art, by providing an improved system for disengaging the safety lock of floor doors.

The purpose is achieved with a control system for disengaging a safety lock of a lift floor door, said safety lock being provided to prevent the door from opening when the lift cabin is absent, said control being characterised in that it comprises: a linear actuation unit; at least one plate made from elastically deformable material; at least one actuation cable between said actuation unit and said plate; said actuation unit, plate and actuation cable being associated with the lift cabin, in which the actuation cable can induce a deformed configuration of said plate, and said plate is positioned so that: when the cabin is present, the plate in deformed configuration disengages said safety lock so as to allow the floor door to open.

The use of an elastically deformable plate makes it possible to considerably reduce the bulk of the control, and to facilitate its assembly as shall become clearer in the rest of the description. Preferably said plate has a flat shape and is substantially an elongated rectangle, but it should be understood that other shapes are possible. Said plate can be made for example from metal, preferably spring steel, or from plastic material that is sufficiently elastically deformable.

In equivalent embodiments of the invention:
i) the plate in resting conditions is substantially flat and bending of the plate, due to traction of the actuation cable, causes the disengagement of the lock, or vice versa,
ii) the plate in resting conditions is curved, preferably in the central part, and its flattening, again due to traction of the actuation cable, causes the disengagement of the lock.

Advantageously, the plate comprises a fixed end firmly attached to a fixed support, and an opposite end that is firmly attached to a mobile support, which can slide linearly in a direction parallel to said plate. Said mobile support constitutes a slide-type constraint. The respective actuation cable is connected to the mobile support. Due to the movement of said mobile support, the deformable plate undergoes a curving or respectively flattens since the end of the plate fixed to the mobile support comes closer or moves away with respect to the other end of the plate which is attached to the fixed support. The changing of configuration of the plate from non deformed to deformed respectively from flat to curved or vice versa, removes the mechanical lock of the floor door.

In a preferred embodiment, the cabin comprises a linear or rotary motor. Said motor is connected by means of a cable or cord, preferably protected by a sheath, to said mobile support or slide.

In a further aspect of the invention, the control comprises a plurality of plates, each plate being connected to the actuation unit with a respective actuation cable, the plates being arranged on different sides of the cabin, so as to allow floor doors, hinged on the right or on the left and positioned on different sides of the well, to open.

The invention can be applied in particular in lifts with manual or semi-manual control of the floor doors. One aspect of the invention is represented by a lift comprising a control for disengaging a safety lock of the floor doors as described.

One advantage of the invention is given by the constructive simplicity and by the small bulk. In particular, the plate has a small projection with respect to the frame of the cabin. Moreover, the number of moving parts is small and it is not necessary to constrain a slider to an articulated system, like in the prior art. Another advantage consists in the possibility of managing lifts with floor doors arranged on different sides with respect to the well and hinged on the right or on the left. Another advantage of the invention is the reliability that is a consequence of the constructive simplicity.

These and other advantages of the invention shall become clearer in the rest of the description, with the help of the description of some preferred but non limiting embodiments, and with the help of the drawings in which:

FIG. 1 schematically shows some components of a control for a floor door, according to one embodiment and showing the unlocking control positioned as if the cabin were on the floor;

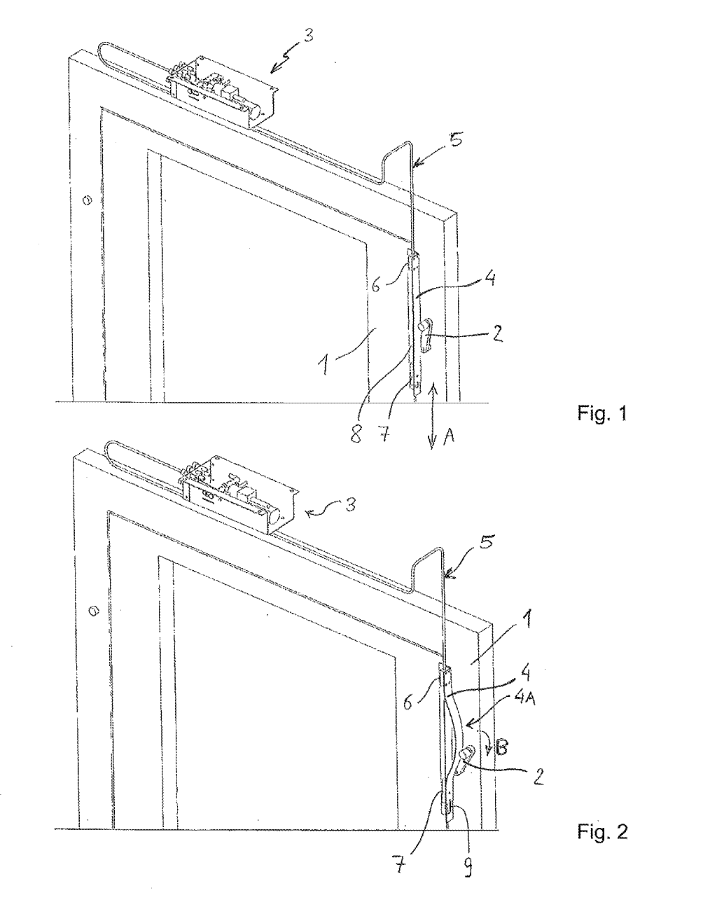

FIG. 2 is analogous to FIG. 1, and shows the control in the position with the door unlocked;

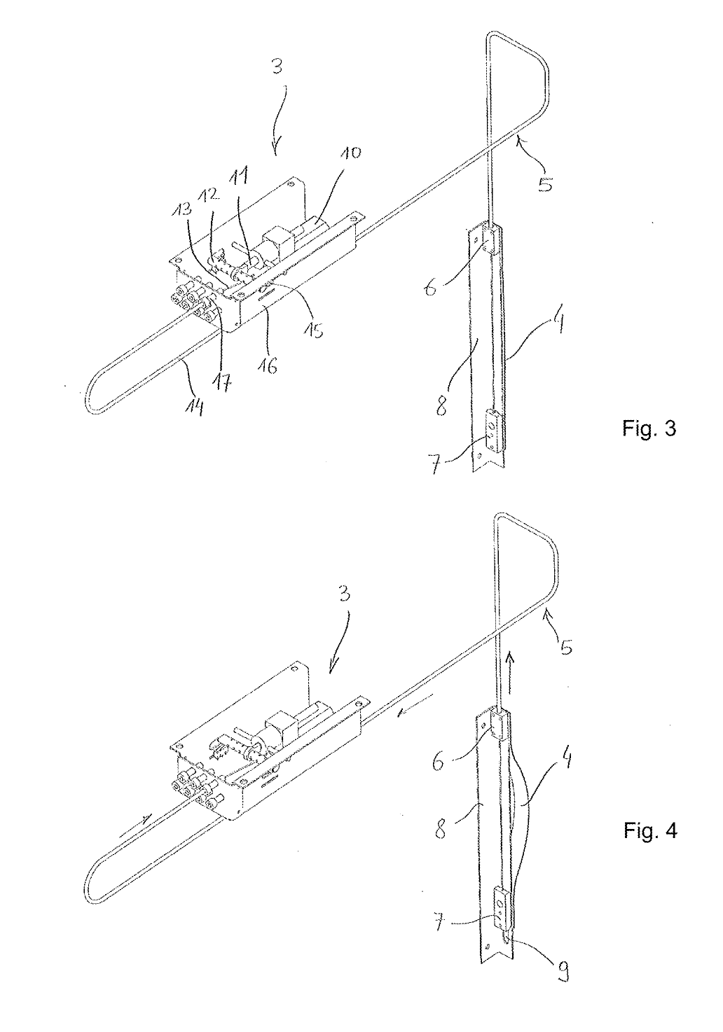

FIGS. 3 and 4 show the main components of the system in greater detail, respectively in locked and unlocked door conditions, according to one embodiment;

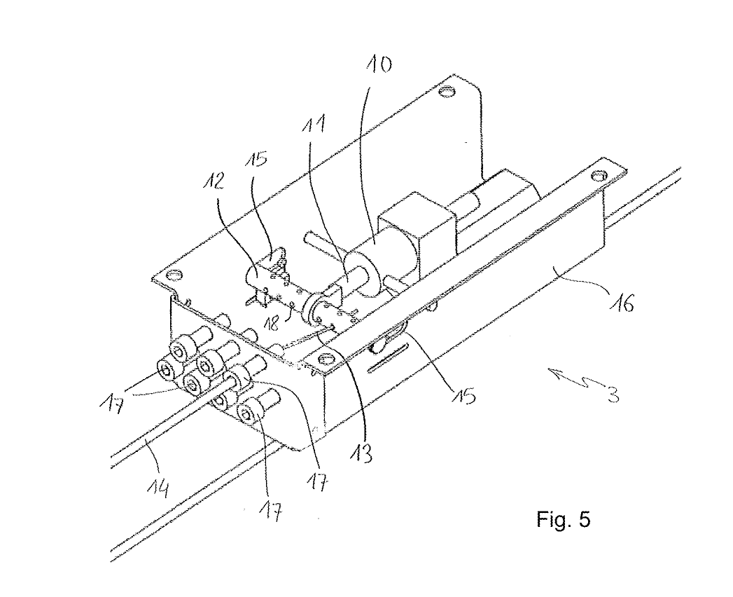

FIG. 5 is a detail of the linear motor unit;

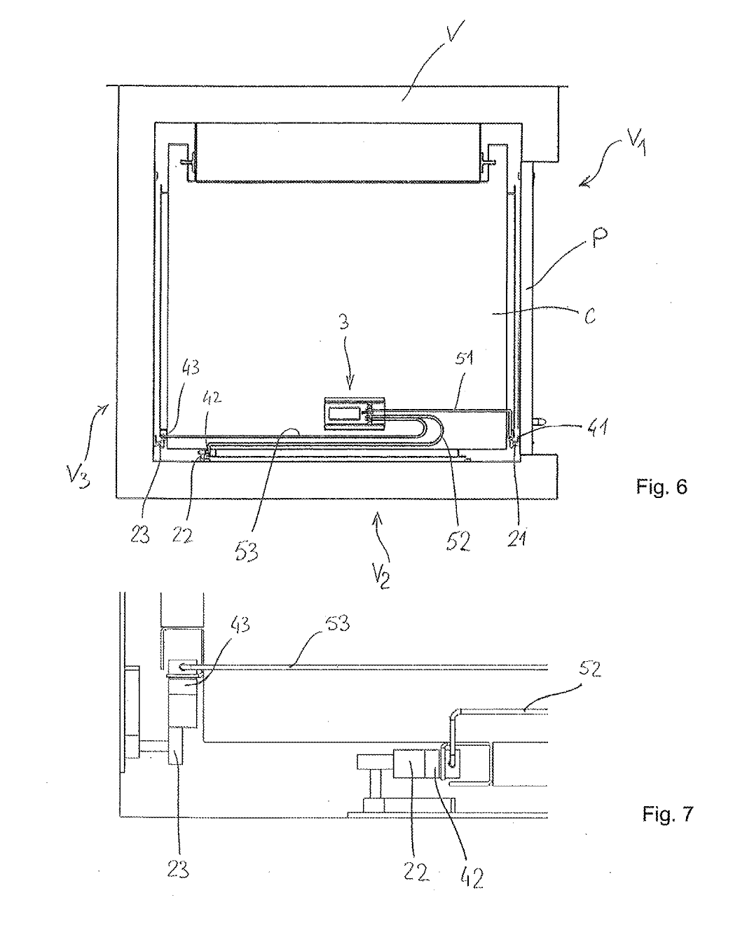

FIG. 6 is a schematic cross section of a lift comprising a system according to the invention, so as to allow the opening of floor doors on different sides of the well hinged on the right or on the left according to the requirements;

FIG. 7 is a detail of FIG. 6;

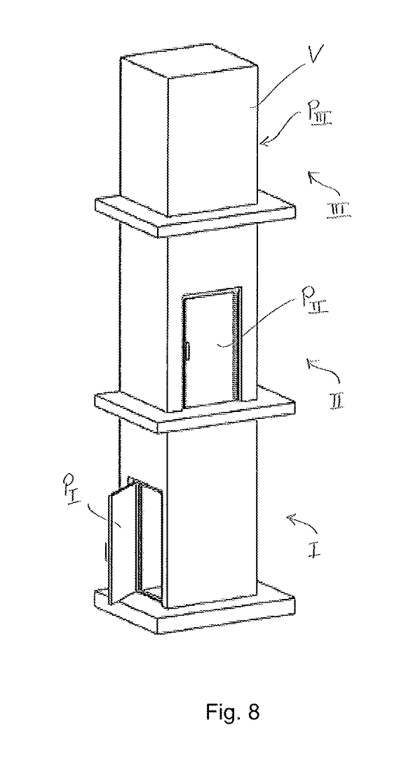

FIG. 8 shows a diagram of a lift with door openings on different sides of the well, and hinged on the right or on the left;

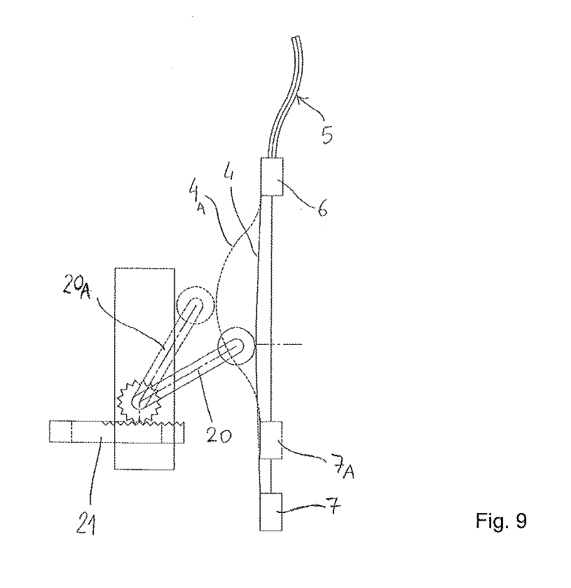

FIG. 9 is a diagram of a floor door mechanical locking and unlocking system, which can be used in some embodiments of the present invention.

### DETAILED DESCRIPTION OF PREFERRED EMBODIMENTS

FIGS. 1-2 show the essential components of a control according to an embodiment of the invention. Reference numeral 1 indicates the frame of a lift floor door. Said door has a safety lock system, which prevents it from opening, controlled by a lever 2. The cabin comprises a control for disengaging the aforementioned lock and allowing the floor door to open. Said control essentially comprises a linear actuation unit 3 connected to a plate 4 made of elastically deformable material, for example spring steel, in contact with said lever 2.

The unit 3 acts upon the plate 4 by means of an actuation cable 5, which shall be illustrated in the rest of the description. The ends of the plate 4 are fixed respectively to a first fixed support 6 and to a second mobile support represented by a slide 7. Said slide 7 can slide in the direction indicated by the double arrow A of FIG. 1, parallel to the main dimension (length) of the plate 4.

FIG. 2 shows the deformed configuration of the plate 4, by effect of the traction of the actuation cable 5. It can be seen in the figure how the slide 7 moves, while the opposite support 6 stays still, and consequently how there is a curving 4_{A} of the plate 4. Due to this deformation, the plate 4 acts upon the lever 2, in particular the curving 4_{A} causes a rotation of the lever in the direction indicated with B (FIG. 2). Such a rotation B of the lever 2 disengages the safety lock and allows the floor door to open when the cabin is present.

It should be noted that a substantially reversed embodiment is also possible in which the plate in resting condition is curved (FIG. 2) and a traction of the actuation cable 5 has the effect of flattening the plate 4, bringing it into the configuration of FIG. 1, thus freeing the mechanical lock. In such a case the support 6 will be mobile and the support 7 will be fixed. The main advantage of this variant consists of keeping the plate curved even when the respective switch has not been actuated.

Details of the actuator unit 3, according to a preferred embodiment, are shown in FIGS. 3 and 4. The actuator unit 3 comprises a motor 10 housed in a container 16 fixed to the lift cabin, for example on the roof of the cabin. Said motor 10 linearly actuates a pin 11 with an eyelet that moves forward or backward a cylinder 12, guided by slots 15 of the side walls of the container 16. A first end of a metal cable or cord 13 is fixed to said cylinder 12; the opposite end of the cable 13 is fixed to the slide 7. Said slide 7 slides in a slot 9 of the support 8 which is visible in FIGS. 2 and 4. The cable 13 is covered by a sheath 14 and comes out from a guide pin 17.

As more clearly visible in the detail of FIG. 5, the unit 3 is foreseen to simultaneously control a plurality of cables 13, having a plurality of holes 18 on the cylinder 12, and a plurality of guide pins 17. This characteristic of the invention makes it possible to simultaneously control a plurality of plates 4 arranged on different sides of the cabin, and is useful in systems where the opening of the doors, on the various floors, is located on different sides of the well and/or is hinged on the right or on the left. Such a characteristic, which forms one of the advantages of the invention, is simplified in FIGS. 6 to 8.

In the example of FIG. 6, an actuation unit 3, preferably fixed on the roof of the cabin C, is connected to three actuation cables 51, 52, 53, which act upon respective door locking/unlocking levers 21, 22 and 23 through respective deformable plates 41-43 analogous to the plate 4. Two of these plates 42, 43 are shown in the detail of FIG. 7.

FIG. 6 illustrates a well V, in section corresponding to a certain floor in which the floor door P is present on the side V₁ of the well V. The lever 21 consequently unlocks the floor door P; however, the system, also comprising the controls 52, 53 for the levers 22, 23, is capable of also unlocking a floor door present on the lateral side V₂ or V₃ opposite the side V1.

When the cabin C reaches a certain floor, the actuation unit 3 simultaneously causes the deformation (for example the curving as shown in FIG. 4) of all the plates 41, 42, 43; according to the floor only one of the plates will meet the locking lever 21, 22 or 23, and will unlock the respective door. For example in FIG. 6 it is clear that the plates 42 and 43 deform “idly”, whereas the plate 41 meets the lever 21 of the door P unlocking the safety lock and allowing it to open.

This characteristic is particularly useful in lifts of the type given as an example in FIG. 8, in which on the respective floors I, II and III there are floor doors P_{I}, P_{II} and P_{III} on different sides of the well V and that are hinged on the right or on the left. FIG. 6 makes it possible to appreciate the very small bulk of the control obtained according to the invention.

With reference now to FIG. 9, in a preferred embodiment, the plate 4 disengages the mechanical lock of the floor door by moving a roller lever 20 that moves a bolt 21. These details, like the lever 20 and the bolt 21, can be made like in the prior art. Due to traction of the actuation cable 5, the slide 7, the plate 4 and the lever 20 are respectively brought into the positions indicated with reference numerals 7_{A}, 4_{A} and 20_{A}, disengaging the bolt 21. It should be noted that the choice of the system for locking and unlocking the floor door (mechanical bolt or other) is not essential for the purposes of the invention and can be made based upon a technique known in the field.

One example of operation is as follows. The cabin stops at the floor thanks to magnetic sensors positioned on every floor, which give the information of the position of the cabin to the card for controlling the lift. The card controls the stopping of the motor of the lift and the unlocking of the lock of the door through the actuation of the slider, thus supplying power to the unit 3.

The system comprises two end stops which limit the maximum stroke of the slider system, i.e. the maximum stroke of the pin 11. When the cabin arrives at the floor the motor 10 is supplied with power until there is the action of an end stop. The intervention of the end stop interrupts the power supply of the motor and the plate stays in the curved position while the lift cabin is at the floor. When the control card receives a call, the motor 10 is supplied with power to bring the slider back in the retracted position until a second end stop intervenes. After the intervention of said second end stop, the feeding of the motor 10 is interrupted and the plate remains undeformed for the entire stroke of the lift.

1. Control system for disengaging a safety lock of a lift floor door, said safety lock being provided to prevent the door from opening when the lift cabin is absent, said control being wherein it comprises: a linear actuation unit; at least one plate made of elastically deformable material; at least one actuation cable between said actuation unit and said plate; said actuation unit, said plate and said actuation cable being associated with the lift cabin, wherein the actuation cable can induce a deformed configuration of said plate, and said plate is positioned so that: when the cabin is present, the plate in deformed configuration disengages said safety lock so as to allow the floor door to open.

2. Control system according to claim 1, said plate having a flat shape, substantially an elongated rectangle.

3. Control system according to claim 2, said plate being made from spring steel.

4. Control system according to claim 2, said plate being made from elastically deformable plastic material.

5. Control system according to claim 1, wherein said plate comprises one fixed end that is firmly attached to a fixed support, and one mobile end that is firmly attached to a mobile support that can slide linearly in a direction parallel to said plate, said actuation cable being connected to the mobile support.

6. Control system according to claim 5, wherein the linear sliding of said mobile support causes a curving or flattening of the plate, respectively, and the change in configuration of the plate from flat to curved, or viceversa, disengages said safety lock.

7. Control system according to claim 1, wherein the actuator unit comprises a motor housed in a container fixed to the lift cabin; said motor linearly actuates a pin with an eyelet that pulls a cylinder forwards or backwards; a first end of at least one metal cable or cord is fixed to said cylinder and the opposite end of said cable is fixed to the mobile support of a respective plate.

8. Control system according to claim 1, comprising a plurality of plates, each plate being connected to the actuation unit with a respective actuation cable, the plates being arranged on different sides of the cabin, so as to allow floor doors positioned on different sides of the well and hinged on the right or on the left, to open.

9. Lift comprising a control system for disengaging a safety lock of the floor doors according claims 1.
